(19) United States
(12) Patent Application Publication
(10) Pub. No.: US 2019/0380499 A1
(43) Pub. Date: Dec. 19, 2019

(54) Drawer that is easily accessible on a chair by a disabled person or elderly person who has difficulty with standing or sitting

(71) Applicant: Beangsuk Kang, Jinhae-gu (KR)

(72) Inventor: Beangsuk Kang, Jinhae-gu (KR)

(21) Appl. No.: 16/012,378

(22) Filed: Jun. 19, 2018

(51) Int. Cl. A47C 7/62; A61G 5/14; E05B 65/46

(52) U.S. Cl. CPC A47C 7/624; A47B 2088/901; E05B 65/46; A61G 5/14

(57) ABSTRACT

The present invention is a drawer that is easily accessible on a chair by a disabled person or elderly person who has difficulty with standing or sitting. The drawer is on the side of the chair. The drawer can be reached while the person is sitting. There is a cover over the drawer, and the cover opens sideways.

The present invention can be applied to multi-use sofas with armrests on both sides.

The present invention can utilize electronic locking on one or both sides of the drawer near the top of the drawer. The present invention can also utilize biometric fingerprints as a means of locking.

The present invention allows access to the drawer using only one's arms, so no standing up is necessary.

### BACKGROUND

Currently it is difficult for a disabled or elderly person to access a drawer while sitting. Regarding side tables next to sofas, it is necessary to stand up to use the drawer.

The disabled or elderly can need many things after they sit down in chairs, and they cannot easily access them.

### SUMMARY OF INVENTION

The present invention is a drawer that is easily accessible on a chair by a disabled person or elderly person who has difficulty with standing or sitting. The drawer is on the side of the chair. The drawer can be reached while the person is sitting. There is a cover over the drawer, and the cover opens sideways.

The present invention can be applied to multi-use sofas with armrests on both sides.

The present invention can utilize electronic locking on one or both sides of the drawer near the top of the drawer. The present invention can also utilize biometric fingerprints as a means of locking.

The present invention allows access to the drawer using only one's arms, so no standing up is necessary.

### BRIEF DESCRIPTION OF DRAWINGS

FIG. 1illustrates a system including one embodiment of the present invention.

FIG. 2 illustrates a system including one embodiment of the present invention.

FIG. 3 illustrates a system including one embodiment of the present invention.

FIG. 4 illustrates a system including one embodiment of the present invention,

FIG. 5 illustrates a system including one embodiment of the present invention.

FIG. 6 illustrates a system including one embodiment of the present invention.

FIG. 7 illustrates a system including one embodiment of the present invention.

### DETAILED DESCRIPTION

The present invention is a drawer that is easily accessible on a chair by a disabled person or elderly person who has difficulty with standing or sitting. The drawer is on the side of the chair. The drawer can be reached while the person is sitting. There is a cover over the drawer, and the cover opens sideways.

The present invention allows access to the drawer using only one's arms, so no standing up is necessary.

The present invention can be applied to multi-use sofas with armrests on both sides,

The present invention can utilize electronic locking on one or both sides of the drawer near the top of the drawer. The present invention can also utilize biometric fingerprints as a means of locking.

The present invention can be of any size that fits within the side area of a chair

The drawer is not built into the seat, and there is no drawer at the bottom of the seat.

The drawer does not interfere with any leg-raising device built into the chair.

In one embodiment of the present invention, the drawer may be motorized so that it moves automatically once opened.

In one embodiment of the present invention, in a one-person sofa, there may be drawers located on both armrests of the chair.

In one embodiment of the present invention, on one side of the chair is a normal drawer, and on the other side is a drawer with a cover. The drawer with a cover goes completely outward and moves upwards to the top of the armrest and attaches to the sides as high as the armrest.

In one embodiment of the present invention, on the top of the armrest of the chair is a storage box with a folding cover.

The cover of the drawer opens sideways.

The user can put anything the user removed from the drawer on the open cover.

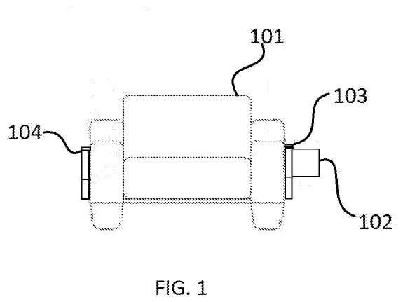

FIG. 1 depicts a chair with one embodiment of the present invention. It includes a chair 101, a cover of the drawer 102, an area where the locking mechanist is located 103, and another drawer 104 on the other side of the chair.

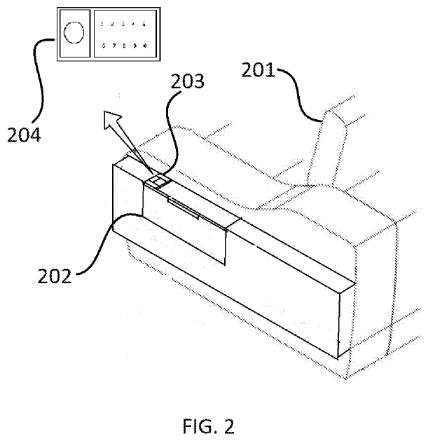

FIG. 2 depicts an oblique view of the left part of the chair with an embodiment of the present invention. It includes a chair 201, a drawer 202 on die left side of the armrest of the chair, and a locking mechanism 203 on the top side of the drawer. It also displays what the locking mechanism would look like, in terms of a numerical panel 204.

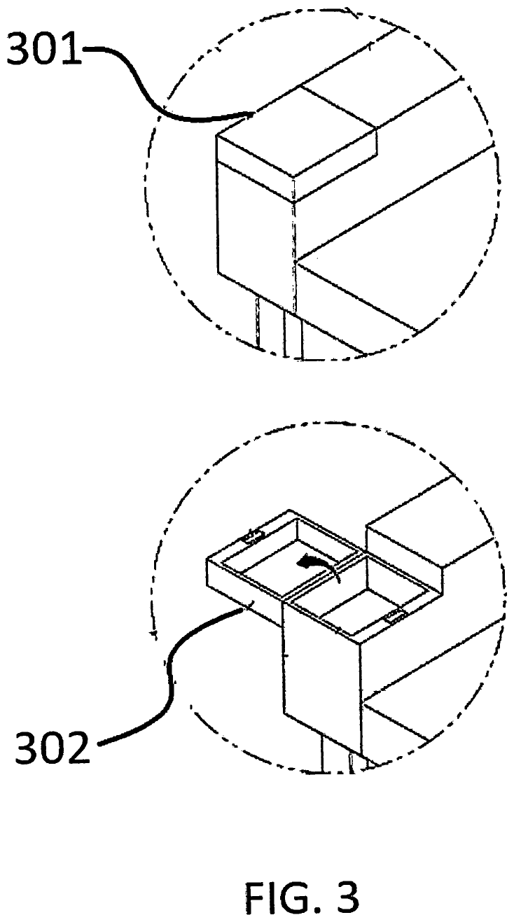

FIG. 3 depicts an oblique view of the part of the chair with an embodiment of the present invention. It includes a storage box 301, and the motion and direction of 1 way that the drawer could be opened, wherein the top 302 of the storage box 301 is rotated vertically 180 degrees, and hangs off the chair, allowing the inside of the storage box 301 to be accessible.

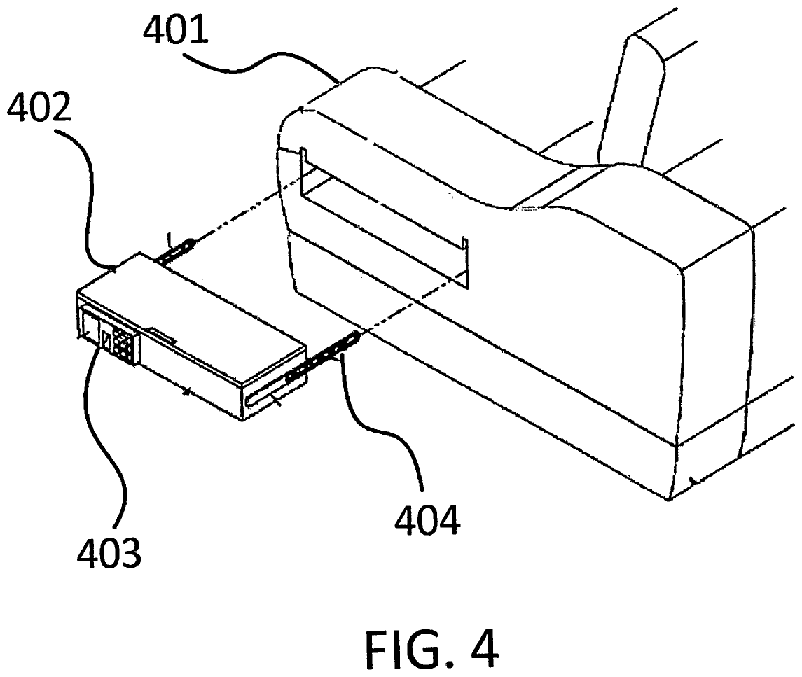

FIG. 4 depicts an oblique view of the left part of the chair with an embodiment of the present invention. It includes a chair 401, and a drawer 402 on the left side of the armrest of the chair, wherein the drawer is shown as it would be if it were removed from the chair. In this embodiment, the locking mechanism 403 is on the left side of the drawer. Additionally, the sliding mechanism 404 by which the drawer comes out of the chair is displayed.

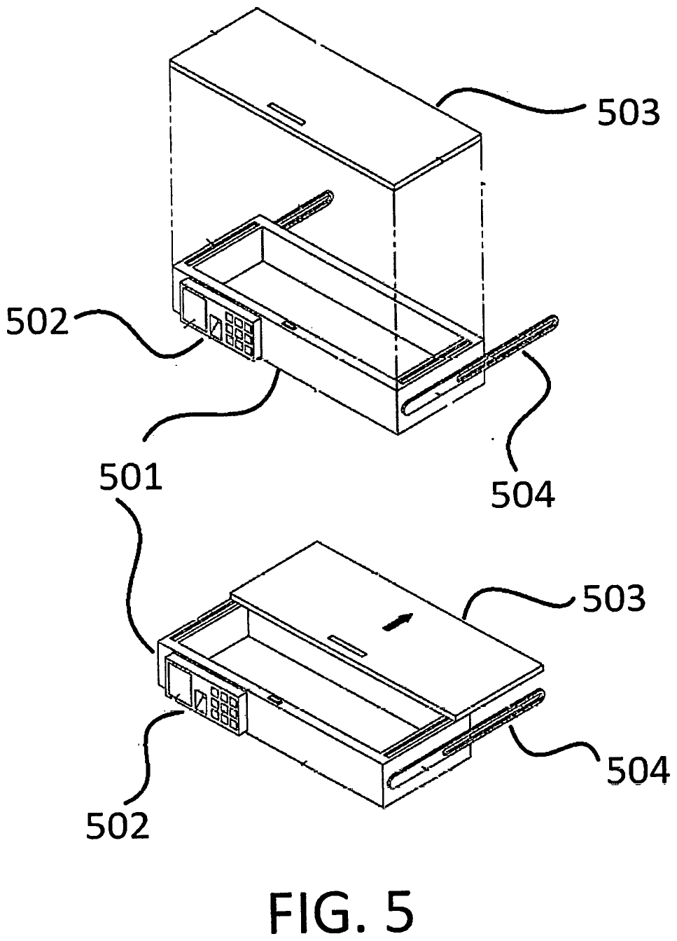

FIG. 5 depicts 2 oblique views from the top of the drawer that is part of an embodiment of the present invention. It includes a storage box 501, a locking mechanism 502, a movable support plate 503 on the top of the drawer, and a sliding mechanism 504 by which the drawer comes out of the chair is displayed.

The movable support plate 503 is connected to the storage box 501 by the sliding mechanism 504 on top of the storage box 501. The lower surface of the movable support plate 503 is opened to open and close the open top of the storage box 501.

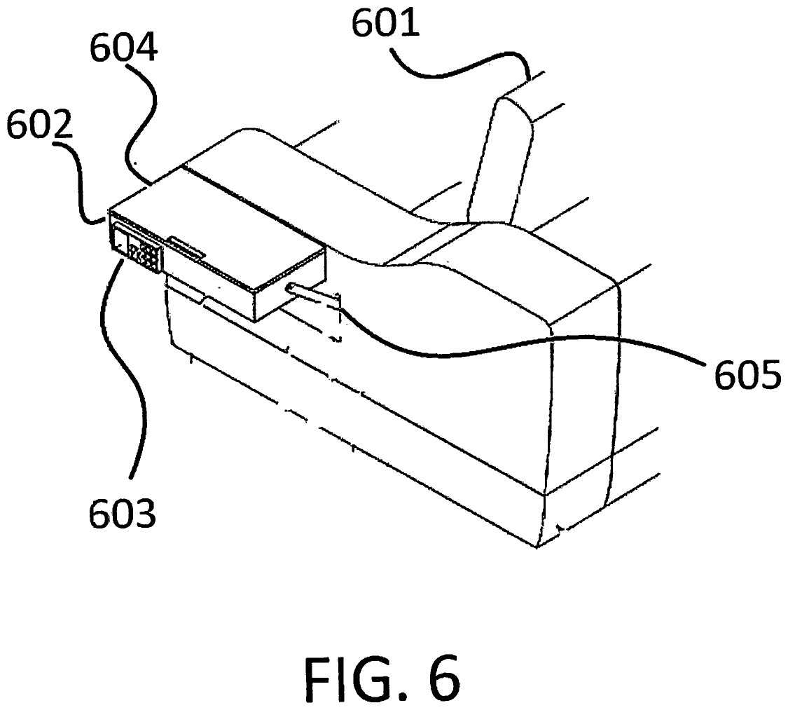

FIG. 6 depicts an oblique view of the left part of the chair with an embodiment of the present invention. It includes a chair 601, and a drawer 602 on the left side of the armrest of the chair, wherein the drawer is shown as it would be if it were removed from the chair. In this embodiment, the locking mechanism 603 is on the left side of the drawer. Additionally, the sliding mechanism 604 by which the drawer comes out of the chair is displayed. This embodiment also includes a stick 605, which can be pulled so as to push the drawer out of the seat, after which the drawer can be opened.

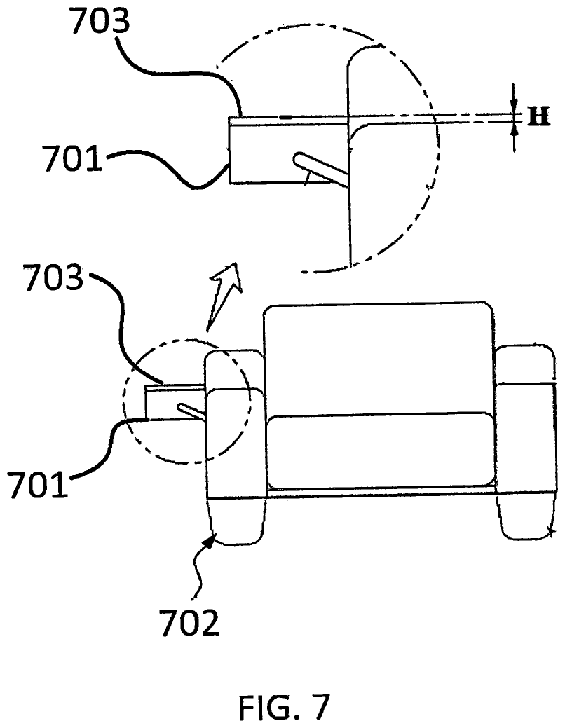

FIG. 7 depicts a view of the chair and a zoomed in portion with an embodiment of the present invention.

The support plate 703 is fixed to the storage box 701 by the fixing protrusion of the storage box 701.

The storage box 701 is easily inserted into the upper portion of the armrest portion 10

The lower surface of the support plate 703 is opened to open and close the open top of the storage box 701.

The top of the storage box 701 is arranged higher than the upper surface of the armrest portion 702 so as to have a predetermined height H.

The storage box 701 can be attached to the armrest portion 702.

The above descriptions are merely preferred examples of the present invention, and are limited to this invention. Any modifications, equivalent replacements and improvements made within the spirit and principle of the present invention should be included within the scope of protecting this invention.

What is claimed is:

1. A system for easy access on a chair to a drawer that is on the side of the chair,
wherein the drawer can be reached while the person is sitting;
wherein there is a cover over the drawer, and the cover opens sideways;
wherein the drawer uses a locking mechanism to protect the contents of the drawer;
wherein the drawer slides oat of the chair horizontally.

2. The system of claim 1, further comprising:
wherein the locking mechanism being an electronic locking mechanism.

3. The system of claim 1, further comprising:
wherein the locking mechanism being a biometric identification mechanism.

4. The system of claim 1, farther comprising:
wherein on one side of the chair is a normal drawer, and on the other side is a drawer with a cover;
wherein the drawer with a cover goes completely outward and moves upwards to the top of the armrest and attaches to the sides as high as the armrest.

5. The system of claim 1, further comprising:
wherein a stick on the side of the chair can be pulled so as to push the drawer out of the seat, after which the drawer can be opened by lifting the cover.

6. The system of claim 1, further comprising:
wherein the locking mechanism is either an electronic locking mechanism or a biometric identification mechanism:
wherein on one side of the chair is a normal drawer, and on the other side is a drawer with a cover;
wherein the drawer with a cover goes completely outward and moves upwards to the top of the armrest and attaches to the sides as high as the armrest;
wherein a stick on the side of the chair can be pulled so as to push the drawer out of the seat, after which the drawer can be opened by lifting the cover.

7. A system for easy access on a chair to a drawer that is on side of the chair,
wherein the drawer can be reached while the person is sitting;
wherein the drawer uses a locking mechanism to protect the contents of the drawer;
wherein the drawer slides out of the chair horizontally;
wherein the drawer has no cover on top.

8. The system of claim 7, further comprising
wherein the locking mechanism being an electronic locking mechanism.

9. The system of claim 7, further comprising:
wherein the locking mechanism being a biometric identification mechanism.

10. The system of claim 7, further comprising:
wherein a stick on the side of the chair can be pulled so as to push the drawer out of the seat.

11. The system of claim 7, further comprising:
wherein the locking mechanism is either an electronic locking mechanism or a biometric identification mechanism;
wherein a stick on the side of the chair can be pulled so as to push the drawer out of the seat.

12. A system for easy access on a chair to a drawer that is on the side of the chair,
wherein the drawer can be reached while the person is sitting,
wherein the drawer uses a locking mechanism to protect the contents of the drawer;
wherein the drawer slides out of the chair horizontally;
wherein there is a cover over the drawer, and the cover opens sideways:
wherein the cover of the drawer slides forward for easy access to the contents of the drawer;
wherein on one side of the chair is a normal drawer, and on the other side is a drawer with a cover;
wherein the drawer with a cover goes completely outward and moves upwards to the top of the armrest and attaches to the sides as high as the armrest;
wherein the locking mechanism is either an electronic locking mechanism or a biometric identification mechanism.
